(19) United States
(12) Patent Application Publication
(10) Pub. No.: US 2011/0052829 A1
(43) Pub. Date: Mar. 3, 2011

(54) COATING METHOD, COATING STATION, AND METHOD FOR COATING AN OBJECT

(76) Inventor: Gerhard Brendel, Auerbach (DE)

(21) Appl. No.: 12/664,463

(22) PCT Filed: Jun. 12, 2008
(86) PCT No.: PCT/EP2008/057395

§ 371 Date: Jun. 15, 2010

(30) Foreign Application Priority Data
Jun. 12, 2007 (DE) 10 2007 027 078.1

(51) Int. Cl. B05D 1/04; B05B 5/025

(52) U.S. Cl. 427/458; 118/621

(57) ABSTRACT

A powder coating station (1) for electrostatic coating of a first and second side of a work piece 3 moved relative to the coating station (1) comprises at least a first dispensing unit (4, 5) for dispensing coating particles and at least a first electrode arrangement (6, 7, 8, 9) for influencing the coating of the work piece (3) through modification of the field line pattern in the edge regions of the side 3a. A method for coating a first and second side of the work piece (3) comprises the steps: Provision of an arrangement (1) of at least one dispensing unit (4, 5) and at least one electrode arrangement (6, 7, 8, 9) which has at least one electrode and which is assigned to the dispensing unit (4, 5); movement of the work piece (3) relative to the coating station (1) along a path past the arrangement (1); dispensing of a coating composition for coating the work piece (3) during the relative movement of the work piece (3); and application of a positive or negative voltage and/or charge at least during a partial period of the coating process, while the dispensing unit (4, 5) is polarized with a polarity different from that of the electrode arrangement (6, 7, 8, 9).

### FIELD OF THE INVENTION

The present invention relates to a coating apparatus for electrostatic coating of a first side of an object moved relative to the coating apparatus, especially for coating a first surface of a laminar object, and a coating station comprising such a coating apparatus. Furthermore, the invention relates to a method for coating an object, especially for coating a first surface of a laminar object, preferably in the above-mentioned coating apparatus or coating station.

### PRIOR ART

Powder coating stations and powder coating methods comprising electrostatic coating of an object or work piece are known. Coating powder is applied to the work piece. The powder particles adhere by means of electrostatic forces to the work piece. One problem here is that at the edges where the field lines of the electrostatic field are concentrated, edge effects are formed, such that powder application there is particularly extensive. The concentration of the powder at the edges leads to so-called picture framing which should be avoided. One known way of avoiding it is to provide counter-electrodes behind the work piece for the purpose of creating a uniform field line distribution and therefore of preventing a build-up in concentration of powder there. However, this measure does not yield satisfactory results. Especially, the use of counter-electrodes disposed behind the work piece gives rise to so-called pinholing due to voltage shocks, with this effect yielding a non-uniform and brittle coating.

### DISCLOSURE OF THE INVENTION

### Object of the Invention

Proceeding therefrom, the object of the invention is to improve the quality and homogeneity of a powder coating, especially in the edge regions of a laminar object.

### Technical Solution

This object is achieved with a coating apparatus in accordance with claim 1, a coating station in accordance with claim 7 or a method in accordance with claim 9. Advantageous embodiments are the object of the dependent claims.

Accordingly, a coating apparatus is provided for the purpose of electrostatic coating of a first side of an object moved relative to the coating apparatus, especially for the purpose of coating a first surface of a laminar object, said coating apparatus comprising at least one dispensing unit for dispensing a coating composition, and at least one first electrode arrangement for influencing the coating of the object.

Especially, the invention relates to a powder coating station featuring electrostatic coating of an object, which can also be termed the work piece. The coating composition in this case is coating particles or a coating powder which is applied to the work piece in such a manner that the powder particles remain adhering on the work piece by means of electrostatic forces. The invention is not to be limited to powder coating, but is to comprise every electrostatically assisted coating. Especially, the invention relates to the powder coating of derived wood materials, especially MDF (medium density fibreboard) panels for the preparation of high-gloss surfaces which suffer especially from problems with edge effects at the edges of the front faces.

The dispensing unit can be one or more powder gun arrangements, each of which comprises at least one, especially two or more powder guns or blaster (dispensing apparatus). Especially, the dispensing apparatuses, such as powder guns and powder blasters, can be disposed over an area such that a coating region is defined, in which the dispensing apparatuses can apply a corresponding powder or coating composition generally onto a work piece.

Especially, the dispensing unit can have at least one, especially two or more dispensing apparatuses arranged side by side. Especially, rows and/or columns of several dispensing apparatuses (e.g. powder guns) can be disposed transversely, especially perpendicularly, to the direction in which the object moves relative to the dispensing unit. In the event that the especially panel-shaped object or the surface of the work piece to be coated is oriented perpendicularly or vertically, several guns, for example, can be vertically arranged adjacent to one another such that the entire width or height of the object's surface can be coated during longitudinal movement of the object past the dispensing unit.

Usually, the object or work piece to be coated is transported linearly past the apparatus, as a result of which one side is coated. However, the device too can be moved relative to the work piece in order that an entire surface of the work piece may be coated with coating material.

Preferably, the dispensing unit is negatively or positively polarized. Thus, it acts as a negatively charged cathode or a positively charged anode which effects adhesion of the particle on the surface. Preferably, the dispensing apparatus is negatively polarized.

Preferably, the electrode arrangement comprises at least one anode or cathode disposed above and/or below and/or laterally adjacent to the dispensing unit or dispensing apparatus. These anodes or cathodes may be arranged on the same side of the surface to be coated, i.e. instead of the counter-electrode's being provided on the opposite side of the work piece, as is known from the prior art, the anodes or cathodes may be arranged around the negatively or positively polarized powder guns. The anodes or cathodes, commonly also referred to as electrodes, can be disposed in a plane which is parallel to the plane in which the work piece moves, or the electrodes can be provided in various planes parallel to the plane in which the work piece moves. The anodes/cathodes may be at a different potential from the dispensing unit or dispensing apparatus. Especially, they may have the opposite polarity compared to the polarity of the dispensing unit.

Additionally, anodes/cathodes can be disposed above and/or below the work piece passing the powder guns, i.e. the coating region, to influence the field line pattern such that no boundary or edge effects occur in the region of the upper and lower edges (which are essentially transported past the apparatus parallel to the direction of movement). The anodes/cathodes provided before and after the powder guns (relative to the direction in which the object moves) cause the field line pattern generated by the anodes/cathodes to be modified such that no boundary or edge effects occur in the region of the front and rear edges (which are mainly transported perpendicularly past the apparatus). Where the object to be coated, such as an MDF panel, is perpendicularly oriented, during movement through the coating station, there are, for example, on both sides of the dispensing unit/dispensing apparatus one electrode arrangement each (in the transport and opposite directions), as well as anodes/cathodes below and above the dispensing unit, i.e. above the topmost and below the bottom-most dispensing apparatus of the dispensing unit and/or above and/or below the coating region.

Especially, the dispensing unit and/or the electrode arrangement of the coating apparatus are disposed so as to be movable relative to a coating chamber and/or work piece fixture of a coating station. The dispensing unit can, for example, be moved back and forth transversely, especially perpendicularly, to the direction in which the work piece is moving. The powder guns can oscillate back and forth during powder coating. The electrodes can be arranged either rigidly or also flexibly and can execute a movement along with the dispensing unit or independently of the dispensing unit. The result is homogeneous coating along the width of the object's surface.

An inventive coating station comprises a first coating apparatus as described above and a second coating apparatus for the electrostatic coating of a second side of an object moved relative to the second coating apparatus, especially for the coating of a second surface of a laminar object, with at least a second dispensing unit for dispensing a coating composition and at least a second electrode arrangement for influencing the coating of the object. The first apparatus, consisting of dispensing unit and electrode arrangement can be disposed at a first side relative to the object to be coated being transported along a movement path, the other apparatus, consisting of dispensing unit and electrode arrangement can be disposed at another side relative to the object to be coated being transported along a movement path. Especially, the apparatuses can be disposed offset from one another, such that successive coating of the two surfaces avoids interference of one apparatus by the other. The offset here can be 1-times or 1.5-times or some multiple of the extension of the coating region in this direction.

The invention is also achieved by a method for coating a first side of an object, especially for coating a first surface of a laminar object, preferably by means of a coating apparatus or coating station as described above, comprising the following steps: Provision of an arrangement of at least one dispensing unit and at least one electrode arrangement which has at least one electrode and which is assigned to the dispensing unit, movement of the object relative to the coating station along a movement path past the arrangement; dispensing of a coating composition for coating the object during the relative movement of the object; and application of a positive or negative voltage and/or charge to the electrode arrangement, at least during a partial period of the coating process.

Especially, at least a positive voltage (as anode) or negative voltage (as cathode) and/or charge is applied to the electrode arrangement when a front edge approaches or a rear edge of the object moved relative to the coating station moves away, and a certain minimum distance in front of an anode/cathode is not maintained. Especially, a positive/negative voltage is applied to an anode/cathode as long as a front edge of the object (with respect to its direction of movement) is at a certain distance from this anode/cathode, until the edge has passed the anode/cathode (minimum distance). The edge then passes the dispensing unit and the anode/cathode arranged behind it. As soon as the edge passes this electrode, a positive/negative voltage is applied to the anode/cathode until the edge has reached a certain distance from the anode/cathode. The merely intermittent application of the voltage to the electrodes can especially concern (relative to the direction in which the object moves) electrodes arranged before and after the dispensing units. In this way, high-quality coating of the surface of the object is achieved in the edge regions too. Since boundary effects occur near edges, provision is made for switching on these electrodes selectively while the edges are passing the arrangement. The anodes/cathodes, especially disposed relatively above and below the dispensing unit or coating region, can be operated in another mode, however, for example, under constant positive/negative voltage, whereby, overall, the set voltage can be varied with the distance of the dispensing apparatus or the anode/cathode from the surface of the work piece to be coated or the coating region. The corresponding modes of operation can of course also be used for all other electrode arrangements.

Especially, a negative or positive voltage and/or charge can be applied to the dispensing unit during at least one sub-period of the coating process.

The electrode voltage can, for example, be between 10,000 kV and 50,000 kV. It is usually polarized so that it has the opposite sign to the dispensing unit.

In a preferred embodiment, the dispensing unit and/or the electrode arrangement are moved relative to the object in a direction which is non-parallel to the relative direction of movement (v) between the dispensing unit and the electrode arrangement, especially transversely, preferably perpendicularly to the direction in which the object is moving. The movement of dispensing unit and/or electrode arrangement can proceed synchronously or independently of each other.

The object can be perpendicularly or vertically oriented during transport through the coating station. The dispensing unit can then execute a reciprocating up-and-down movement, such that the surface of the object is homogeneously coated along its width (perpendicular to the longitudinal direction or direction of movement).

Protection is sought for the characteristics described, both individually and in any combination with each other.

### BRIEF DESCRIPTION OF THE DRAWINGS

Further advantages, characteristics and features of the present invention are apparent from the following detailed description of an embodiment using the enclosed drawings. The drawings show in:

FIG. 1 a frontal view of the inventive powder-coating station;

FIG. 2 a side view of the inventive powder-coating station, and

FIG. 3 a plan view of the inventive powder-coating station.

### DESCRIPTION OF A PREFERRED EMBODIMENT

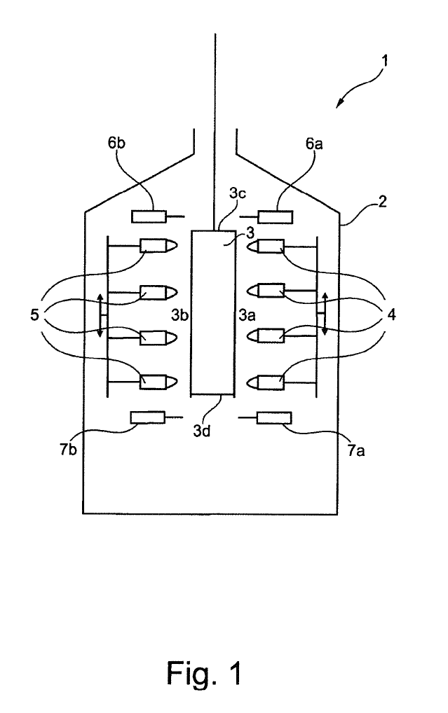

FIG. 1 shows a schematic diagram of an inventive powder-coating station 1. It has a powder booth 2 through which a laminar object 3, e.g., a work piece or substrate, for electrostatic coating with a powder is transported in a direction perpendicular to the plane of the drawing.

The coating powder is provided via powder guns 4 and 5 disposed adjacent to each other in order that they may coat the surfaces 3a or 3b of the substrate 3 disposed opposite them. The powder guns 4 and 5 are negatively polarized to create an electrostatic field and to apply the coating powder such that it adheres on the surfaces 3a and 3b. In addition, both arrangements of powder guns 4 and 5 are arranged on a carrier such that they oscillate perpendicularly (indicated by the double arrows). However, they can also be rigidly disposed.

For the purpose of improving the coating quality of the upper and lower edges of the substrate 3, which are disposed parallel to the direction in which the work piece 3 moves, anodes 6a, 7a, 6b, 7b, each under positive voltage, are provided above and below the gun arrangements 4 and 5. The anodes 6a and 7a influence the electromagnetic field generated in the edge region by the negatively polarized powder gun 4, the anodes 6b and 7b influence the electromagnetic field generated in the edge region by the negatively polarized powder gun 4 such that picture framing or other undesirable effects in the region of the edges of the surfaces 3a and 3b are prevented.

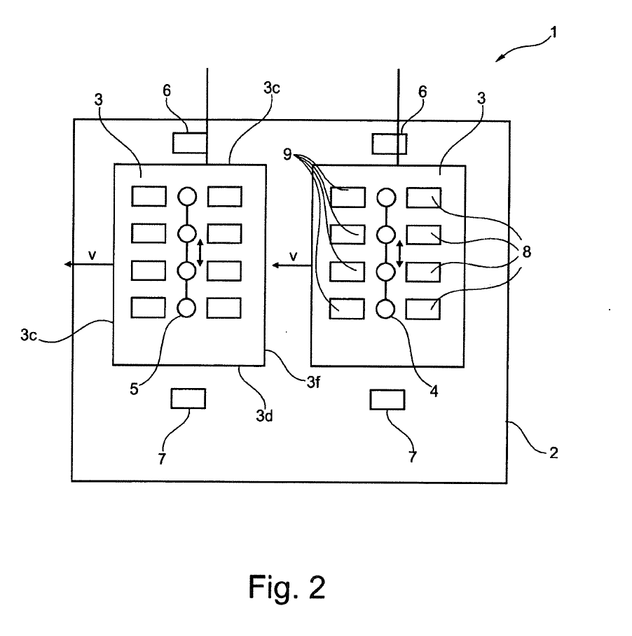

FIG. 2 shows a side view of the powder coating station according to FIG. 1. In the illustration, two work pieces 3 are transported through the powder booth 2 in succession at a velocity v indicated by corresponding arrows. The work pieces thereby define, at least height-wise, the coating region (equivalent to the width of the work piece). On passing the negatively polarized powder guns 4 and 5, shown as circles, the work pieces 3 are coated with the powder dispensed by the guns 4 and 5. The powder gun arrangements 4 and 5, as indicated by corresponding double arrows, are moved up and down in this respect in order that homogeneous coating of the work pieces 3 may be achieved between the upper edges 3c and the lower edges 3d.

To avoid edge effects at the upper edges 3c and lower edges 3d, an upper anode 6 and a lower anode 7 are arranged adjacently above and below the respective gun arrangements 4 and 5. These anodes 6 and 7 are operated continuously, at least while coating is in progress at one of the two coating modules, i.e. they are continuously positively polarized and (compared with the substrate 3) are at a positive electrical potential. The anodes 6 and 7 can be immovable, as shown here, or can move synchronously with the powder guns or move independently (asynchronously) of the powder guns 4, 5.

In addition, laterally adjacent to the powder gun arrangements 4, 5 are disposed first anodes 8, with respect to the direction of movement v, in front of the gun arrangements 4 and 5, and second cathodes 9, with respect to the direction of movement v, behind the pistol arrangements 4 and 5. Controlled connection of the positive potential of these anode arrangements ensures that edge effects are avoided at the front edges 3e and rear edges 3f of the work pieces 3.

All anodes 6, 7, 8, 9, which are assigned to a particular dispensing unit 4 or 5, are disposed on the same substrate side as the respective dispensing unit 4 or 5.

Instead of anodes (in the case of a negatively polarized dispensing unit) cathodes too can be provided (in the case of a positively polarized dispensing unit). In operation, the dispensing unit and the electrodes are at different potentials and are usually of different polarity.

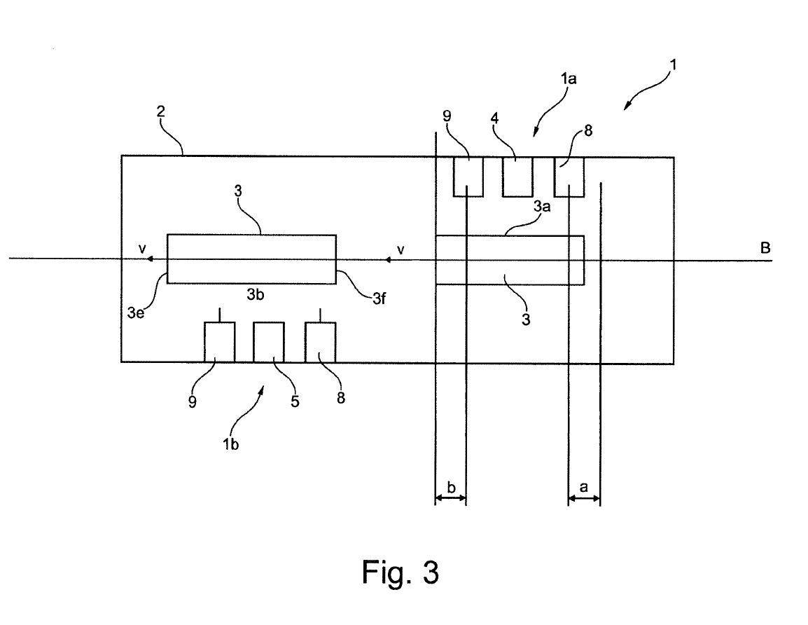

FIG. 3 shows a plan view of the powder coating installation 1, in which two substrates 3 are transported along the transport path and through the powder booth 2 at a velocity v. The coating station 1 comprises a first sub-station 1a for coating a first surface 3a of the substrates 3 transported past, and a second coating station 1b for coating a second surface 3b of the substrates 3.

Both sub-stations 1a and 1b have a front anode arrangement 8 and a rear anode arrangement 9. The anodes 8 and 9, mounted laterally before and after the coating gun arrangements 4 and 5 are only placed under positive voltage intermittently, namely, when the rear edge 3f of a substrate 3 approaches the front anode 8 and breaches a minimum distance a. The potential is turned off when the edge 3f passes the anode arrangement 8.

The rear anode arrangement 9 is turned on as soon as an edge 3e, 3f passes it and is turned off as soon as the edge 3e, 3f b exceeds a distance b. Especially, the values a and b can be about 100 mm. The distance of the work piece 3 from the anodes 8, 9 and the powder guns 4, 5 is in the range of 200 mm. At greater distances, the distances a and b in which the anodes are operated are greater too. For example, the distance can be a=b when the distance between the work piece surface 3a, 3b and the anodes 8, 9 or the powder gun 4, 5 is in the range 150 mm to 50 mm, preferably 75 mm.

In this way, undesirable coating effects, such as so-called pinholing, can be avoided on the surfaces 3a and 3b in the region of the front and rear edge 3e and 3f.

1-15. (canceled)

16. Coating apparatus for electrostatic coating of a first surface of an object moved relative to the coating apparatus comprising:
at least a first dispensing unit for dispensing a coating composition including at least one dispensing apparatus; and
at least one first electrode arrangement for influencing coating of the object, wherein the electrode arrangement comprises at least one of anodes and cathodes disposed at least one position selected from the group comprising a position above, below and laterally to the dispensing unit or dispensing apparatus.

17. Coating apparatus in accordance with claim 16, wherein:
the dispensing unit has at least two adjacent dispensing apparatuses arranged in at least one of rows and columns.

18. Coating apparatus in accordance with claim 16, wherein:
at least one of negative voltage, positive voltage, negative charge and positive charge is applied to at least one of the first dispensing units.

19. Coating apparatus in accordance with claim 16, wherein:
the electrode arrangement has at least one of a anode and a cathode laterally offset relative to the coating region.

20. Coating apparatus in accordance with claim 16, wherein:
the anode or cathode is disposed at a distance of the dispensing apparatus, said distance being at most the distance of the dispensing apparatus from at least one of the work piece surface to be coated and an object path on which the work piece moves.

21. Coating apparatus in accordance with claim 16, wherein:
the anode or cathode is disposed at a distance from the dispensing apparatus, said distance being at most half the distance of the dispensing apparatus from at least one of the work piece surface to be coated and an object path on which the work piece moves.

22. Coating apparatus in accordance with claim 16, wherein:
at least one of the dispensing unit and the electrode arrangement of the coating apparatus are disposed so as to be movable relative to at least one of a coating chamber of a coating station and a work piece fixture.

23. Coating station comprising:
a first coating apparatus for electrostatic coating of a first surface of an object moved relative to the coating apparatus comprising:
at least a first dispensing unit for dispensing a coating composition including at least one dispensing apparatus, and
at least one first electrode arrangement for influencing the coating of the object, wherein the electrode arrangement comprises at least one of anodes and cathodes disposed at least one position selected from the group comprising a position above, below and laterally to the dispensing unit; and
a second coating apparatus for the electrostatic coating of a second surface of the object moved relative to the second coating apparatus comprising:
at least a second dispensing unit for dispensing a coating composition including at least one dispensing apparatus; and
at least a second electrode arrangement for influencing the coating of the object.

24. Coating station in accordance with claim 23, wherein:
the second dispensing unit is disposed mirror-symmetrically opposite the object path, but offset at least by one coating region along an object path.

25. Coating station in accordance with claim 23, wherein:
the second dispensing unit is disposed mirror-symmetrically opposite the object path, but offset at least by more than one along an object path.

26. Method for coating a first surface of a laminar object comprising:
providing of a coating apparatus having at least one electrode arrangement comprising at least one of an anode and cathode;
moving of the object relative to the coating apparatus along an object path;
dispensing a coating composition for coating the object during relative movement of the object; and
supplying of at least one of a positive voltage, negative voltage, positive charge and negative charge to at least one of the anode and cathode of the electrode arrangement at least during a sub-period of the coating process.

27. Method in accordance with claim 26, wherein:
supplying the voltage to at least one of the anode and cathode of the electrode arrangement occurs at least when one edge of the object is moved over a certain region relative to at least one of the anode and cathode.

28. Method in accordance with claim 26, wherein:
the voltage is applied to at least one of the anode and cathode within a region in which one edge of the object is located within a distance being equal to one distance of one of the dispensing unit and dispensing apparatus from one of the object and the object path.

29. Method in accordance with claim 26, wherein:
the voltage is applied to at least one of the anode and cathode within a region in which one edge of the object is located within a distance being equal to half a distance of one of the dispensing unit and dispensing apparatus from one of the object and the object path.

30. Method in accordance with claim 26, wherein:
the voltage is between 10,000 kV and 50,000 kV.

31. Method in accordance with claim 26, wherein:
the voltage is supplied as a function of the distance between the anode or cathode and the coating region.

32. Method in accordance with claim 26, wherein:
the voltage of at least one of anodes and cathodes offset from the coating region is supplied as a function of the distance between the anode or cathode and the coating region.

33. Method in accordance with claim 26, wherein:
at least one of the dispensing unit and the electrode arrangement are moved relative to the object in a direction which is non-parallel to the relative direction of movement between the dispensing unit and the electrode arrangement.

34. Method in accordance with claim 26, wherein:
the surface to be coated is oriented in a direction being selected from one of a vertical and perpendicular orientation during transport through the coating station.

35. Method in accordance with claim 26, wherein:
a coating apparatus is used, which comprises:
at least a first dispensing unit for dispensing a coating composition including at least one dispensing apparatus; and
at least one first electrode arrangement for influencing the coating of the object, wherein the electrode arrangement comprises at least one of anodes and cathodes disposed at at least one position selected from the group comprising a position above, below and laterally to the dispensing unit or dispensing apparatus.
